(19) United States
(12) Patent Application Publication
(10) Pub. No.: US 2025/0006986 A1
(43) Pub. Date: Jan. 2, 2025

(54) LIQUID COMPOSITION, STORAGE CONTAINER, AND APPARATUS AND METHOD FOR PRODUCING SOLID ELECTROLYTE LAYER OR ELECTRODE MIXTURE LAYER

(71) Applicants: Tomomasa Kajita, Kanagawa (JP); Hiromichi Kuriyama, Kanagawa (JP); Satoshi Nakajima, Tokyo (JP); Yuji Sone, Kanagawa (JP)

(72) Inventors: Tomomasa Kajita, Kanagawa (JP); Hiromichi Kuriyama, Kanagawa (JP); Satoshi Nakajima, Tokyo (JP); Yuji Sone, Kanagawa (JP)

(73) Assignee: Ricoh Company, Ltd., Tokyo (JP)

(21) Appl. No.: 18/717,474

(22) PCT Filed: Oct. 28, 2022
(86) PCT No.: PCT/JP2022/040418

§ 371 Date: Jun. 7, 2024

(30) Foreign Application Priority Data
Dec. 16, 2021 (JP) 2021-204139

(51) Int. Cl. H01M 10/0562; H01M 4/04

(52) U.S. Cl. CPC H01M 10/0562; H01M 4/0407; H01M 4/0414; H01M 2300/0077; H01M 2300/008

(57) ABSTRACT

A liquid composition has a solvent, an inorganic solid electrolyte and a dispersant. A solid concentration of the inorganic solid electrolyte in the liquid composition is 20% by mass or higher. The dispersant is soluble in the solvent. A relative permittivity of the solvent at 25° C. is 6.0 or lower.

### TECHNICAL FIELD

The present disclosure relates to a liquid composition, a storage container, and an apparatus and a method for producing a solid electrolyte layer or an electrode mixture layer.

### BACKGROUND ART

Electrochemical elements such as lithium-ion secondary batteries, lithium-ion capacitors, electric double layer capacitors, and redox capacitors are mounted on, for example, electronic appliances and electric vehicles and are widely used. In particular, demand for lithium-ion secondary batteries for vehicles is expected to expand because of the recent years' needs to reduce environmental impacts. In this context, greater improvement in safety and energy density of lithium-ion secondary batteries is required, and active efforts are being made to bring into practical use all-solid-state batteries in which existing electrolytic solutions are replaced with solid electrolytes.

The production processes for solid electrolyte layers of all-solid-state batteries are roughly classified into dry processes and wet processes. In dry processes, dry solid electrolyte powder particles are deployed in a sheet shape, and pressed and sintered, to obtain a sheet-shaped solid electrolyte layer. In wet processes, a coating process using a liquid composition, obtained by mixing a solid electrolyte in a solvent, is used to form the electrolyte layer. In terms of productivity, wet processes are preferred.

From the viewpoint of improving production efficiency when forming solid electrolyte layers, one may consider preparing a slurry that contains a solid electrolyte at a high solid concentration.

For example, a technique using a specific solvent is proposed as a technique aiming for suppressing decrease in the ion conductivity of a solid electrolyte (for example, see PTL 1). The proposed technique sets forth that it is also possible to obtain a composition excellent in slurry retainability and a slurry coating property by using the solvent.

A solid electrolyte composition that contains: a polymer containing a constituent derived from a macromonomer satisfying a predetermined condition; and a dispersion medium is proposed as a technique that exploits an excellent dispersibility for, for example, improvement of the production efficiency of all-solid-state secondary batteries (for example, see PTL 2).

A technique using solid electrolyte particles having a predetermined particle diameter is proposed as a technique aiming to provide, for example, a solid electrolyte that can retain a slurry state for a certain time duration when it is mixed in a liquid (for example, see PTL 3).

### CITATION LIST

### Patent Literature

[PTL 1] International Publication No. WO 2016/013224
[PTL 2] International Publication No. WO 2019/054455
[PTL 3] Japanese Unexamined Patent Application Publication No. 2009-211950

### SUMMARY OF INVENTION

### Technical Problem

According to the present disclosure, it is an object to provide a liquid composition that can suppress emission of hydrogen sulfide and improve the dispersibility of an inorganic solid electrolyte even when it contains the inorganic solid electrolyte at a high concentration, and that can be discharged by an inkjet method.

### Solution to Problem

According to an embodiment of the present disclosure, a liquid composition contains a solvent, an inorganic solid electrolyte, and a dispersant. The solid concentration of the inorganic solid electrolyte in the liquid composition is 20% by mass or higher. The dispersant is soluble in the solvent. The relative permittivity of the solvent at 25° C. is 6.0 or lower.

### Advantageous Effects of Invention

According to the present disclosure, it is possible to provide a liquid composition that can suppress emission of hydrogen sulfide and improve the dispersibility of an inorganic solid electrolyte even when it contains the inorganic solid electrolyte at a high concentration, and that can be discharged by an inkjet method.

### BRIEF DESCRIPTION OF DRAWINGS

FIG. 1 is an exemplary view illustrating an example of an apparatus configured to produce a solid electrolyte layer or an electrode mixture layer for realizing a method for producing a solid electrolyte layer or an electrode mixture layer of the present disclosure.

FIG. 2 is an exemplary view illustrating another example of an apparatus (liquid discharging apparatus) configured to produce a solid electrolyte layer or an electrode mixture layer for realizing a method for producing a solid electrolyte layer or an electrode mixture layer of the present disclosure.

FIG. 3 is an exemplary view illustrating an example of a power storage element including a solid electrolyte layer of the present disclosure.

### DESCRIPTION OF EMBODIMENTS

### (Liquid Composition)

An embodiment of a liquid composition of the present disclosure contains a solvent, an inorganic solid electrolyte, and a dispersant, and further contains other components as needed (hereinafter, this embodiment may be referred to as “the first embodiment”). Another embodiment of the liquid composition of the present disclosure is a liquid composition for being discharged using an inkjet head, and contains a solvent, an inorganic solid electrolyte, and a dispersant, and further contains other components as needed (hereinafter, this embodiment may be referred to as “the second embodiment”).

As described above, in terms of productivity, wet processes are preferred as the production process for solid electrolyte layers of all-solid-state batteries. However, inorganic solid electrolytes, particularly, sulfide solid electrolytes containing elemental sulfur react not only with water but with organic solvents and emit harmful hydrogen sulfide. Therefore, there has been a limitation to the solvents that are suitable for use in the wet coating processes.

From the viewpoint of improving production efficiency when forming solid electrolyte layers, one may consider preparing a slurry that contains an inorganic solid electrolyte at a high solid concentration. However, a liquid composition prepared to contain an inorganic solid electrolyte at a high solid concentration has flocculation of the inorganic solid electrolyte, or is thickened in viscosity.

Existing techniques have made various studies as described above, but have barely succeeded in suppressing flocculation, maintaining dispersibility, and exhibiting inkjet discharging performance even when the concentration of the inorganic solid electrolyte (hereinafter, may be referred to as an “ion-conductive material”) is high.

The present inventors have found that a liquid composition containing a solvent, an inorganic solid electrolyte, and a dispersant, wherein the dispersant is soluble in the solvent and the solvent has a relative permittivity of 6.0 or lower at 25° C., can qualify as a liquid composition that can suppress emission of hydrogen sulfide and improve the dispersibility of the inorganic solid electrolyte even when the solid concentration of the inorganic solid electrolyte in the liquid composition is a high concentration of 20% by mass or higher, and that can be discharged by an inkjet method.

In the present specification, a liquid composition that can be discharged by an inkjet method represents one that can be continuously discharged for 60 seconds or longer through one nozzle (having a nozzle diameter of 40 micrometers) of an inkjet head of a liquid droplet observation instrument EV1000 (available from Ricoh Company, Ltd.). When it is said that a liquid composition can be continuously discharged for 60 seconds or longer, the amount of the liquid composition discharged is no object so long as the liquid composition is kept discharged at least 60 seconds after it starts to be discharged. That is, so long as the liquid composition can be continuously discharged for at least 60 seconds from when it starts to be discharged, the amount of the liquid composition discharged may change or need not necessarily change through the period of time from the start of discharging until 60 seconds after the start of discharging.

### <Solvent>

### First Embodiment

The solvent of the first embodiment is not particularly limited and may be appropriately selected in accordance with the intended purpose so long as the solvent has a relative permittivity of 6.0 or lower at 25° C. When the relative permittivity of the solvent is 6.0 or lower, the inorganic solid electrolyte can have a high dispersibility in the solvent regardless of whether the inorganic solid electrolyte is an inorganic solid electrolyte containing elemental sulfur or an inorganic solid electrolyte containing elemental oxygen. When such a solvent is used in combination with an inorganic solid electrolyte containing elemental sulfur, a reaction between a solvent and an inorganic solid electrolyte containing elemental sulfur is less likely to occur, making it possible to suppress emission of harmful hydrogen sulfide. One of such solvents as described above may be used alone or two or more of such solvents as described above may be used in combination. When using a mixed solvent in which two or more solvents are combined, the requisite relative permittivity of 6.0 or lower is applicable to the mixed solvent.

The method for measuring the relative permittivity of the solvent is not particularly limited and may be appropriately selected in accordance with the intended purpose. For example, the relative permittivity of the solvent may be measured with MODEL 871 (available from Sanyo Trading Co., Ltd.) at 10 kHz according to a current measurement method using a double cylindrical tube.

Specific examples of the solvent include pentane, isopentane, hexane, heptanc, 2,2-dimethyl butane, octane, cyclohexane, tetradecane, 1,4-dioxane, benzene, xylene, carbon tetrachloride, mesitylene, toluene, dibutyl ether, anisole, 1,2-diethoxyethane, 2-methyl anisole, 3-methyl anisole, 4-methyl anisole, 1,2-methoxybenzene, 1,3-methoxybenzene, p-ethyl aniline, 4-octanol, phenetole, 2-ethylhexyl acetate, butylphenyl ether, isopropyl benzene, 1,2,3,4-tetrahydronaphthalene, ethyl decanoate, isobutyl acetate, diisopentyl ether, tridecane, cyclooctane, and ethyl propionate.

As the solvent, a dehydrated one is preferable. The degree of dehydration is not particularly limited and may be appropriately selected in accordance with the intended purpose. A water content of the solvent measured with a Karl Fischer moisture titrator is preferably 1,000 ppm or less, more preferably 100 ppm or less, and yet more preferably 10 ppm or less.

### Second Embodiment

The solvent of the second embodiment is the same as the solvent of the first embodiment described above.

### <Inorganic Solid Electrolyte>

### First Embodiment

The inorganic solid electrolyte of the first embodiment is not particularly limited so long as the inorganic solid electrolyte is free of electron conductivity and has ion conductivity. Among inorganic solid electrolytes, sulfide solid electrolytes containing elemental sulfur in the composition formula, or oxide solid electrolytes containing elemental oxygen as the anion are preferable in terms of ion conductivity, and sulfide solid electrolytes are preferred because of their high plasticity that enables formation of a good interface between solid electrolyte particles or between the solid electrolyte and an active substance. As needed, one such inorganic solid electrolyte may be used, or two or more such inorganic solid electrolytes may be used.

### —Sulfide Solid Electrolytes—

The sulfide solid electrolytes are roughly classified into crystalline sulfide solid electrolytes and glassy solid electrolytes.

The crystalline sulfide solid electrolytes are not particularly limited and may be appropriately selected in accordance with the intended purpose. Examples of the crystalline sulfide solid electrolytes include Li_{9.54}Si_{1.74}P_{1.44}S_{11.7}Cl_{0.3}, Li_{9.6}P₃S₁₂, Li₉P₃S₉O₃, Li_{9.81}Sn_{0.81}P_{2.19}S₁₂, Li_{9.42}Si_{1.02}P_{2.1}S_{9.96}O_{2.04}, Li₁₀Ge(P₁₋ₓSbₓ)₂S₁₂(0≤x≤0.15), Li₁₀SnP₂S₁₂, Li_{10.35} [M₁₋ₓM2ₓ]_{1.35}P_{1.65}S₁₂ (where M1 and M2 represent any of Si, Ge, Sn, As, and Sb, 0≤x≤0.15), Li₁₁Si₂PS₁₂, Li₁₁AlP₂S₁₂, Li_{3.45}Si_{0.45}P_{0.55}S₄, Li₆PS₅X (where X represents any of Cl, Br, and I), Li₅PS₄X₂ (where X represents any of Cl, Br, and I), Li_{5.5}PS_{4.5}Cl_{1.5}, Li_{5.35}Ca_{0.1}PS_{4.5}Cl_{1.55}, Li₆₊ₓMₓSb₁₋ₓS₅I (where M represents any of Si, Ge, and Sn, 0≤x≤1), Li₇P₂S₈I, γ-Li₃PS₄, Li₄MS₄ (where M represents any of Ge, Sn, and As), Li₄₋ₓSn₁₋ₓSbₓS₄ (0≤x≤0.15), Li₄₋ₓGe₁₋ₓPₓS₄ (0≤x≤0.15), and Li₃₊₅ₓP₁₋ₓS₄ (0≤x≤0.3).

The glassy sulfide solid electrolytes are not particularly limited and may be appropriately selected in accordance with the intended purpose. Examples of the glassy sulfide solid electrolytes include Li₂S—P₂S₅, Li₂S—P₂S₅—LiI, Li₂S—P₂S₅—P₂O₅, Li₂S—P₂S₅—LiCl, Li₂S—SiS₂, Li₂S—SiS₂—P₂S₅, Li₂S—SiS₂—Al₂S₃, and Li₂S—SiS₂—LiₓMO_{y} (where M represents any of Si, P, and Ge). In addition, for example, Li₇P₃S₁₁ glass ceramic, which is a partly crystallized glassy sulfide solid electrolyte, may also be used. There is no specific requisite mix ratio between the materials of the glassy sulfide solid electrolyte.

### —Oxide Solid Electrolyte—

As the oxide inorganic solid electrolytes, any compounds that contain elemental oxygen (O), have conductivity of ions of metals belonging to Group I or II of the periodic table, and have an electron insulating property are preferable.

The oxide solid electrolytes are roughly classified into crystalline oxide solid electrolytes and glassy oxide solid electrolytes.

The crystalline oxide solid electrolytes are not particularly limited and may be appropriately selected in accordance with the intended purpose. Examples of the crystalline oxide solid electrolytes include Li₁₊ₓMₓTi₂₋ₓ(PO₄)₃ (where M represents any of Al, Cr, Ga, Fc, Sc, In, Lu, Y, and La, 0≤x≤0.5), LaₓLi_{y}TiO₃ (0.3≤x≤0.7, 0.3≤y≤0.7), and Li₇₋ₓ La₃Zr₂₋ₓMₓO₁₂ (where M represents Nb or Ta, 0≤x≤1).

The glassy oxide solid electrolytes are not particularly limited and may be appropriately selected in accordance with the intended purpose. Examples of the glassy oxide solid electrolytes include Li₄SiO₄—Li₂BO₃, Li₃BO₃—Li₂SO₄, Li₂O—B₂O₃—P₂O₅, and Li₂O—SiO₂.

As the inorganic solid electrolyte, a product prepared by a publicly-known method or a commercially available product may be used.

The content of the inorganic solid electrolyte in the liquid composition is not particularly limited and may be appropriately selected in accordance with the intended purpose so long as the solid concentration of the inorganic solid electrolyte is 20% by mass or higher. The solid concentration of the inorganic solid electrolyte is more preferably 30% by mass or higher. The upper limit is not particularly limited, may be appropriately selected in accordance with the intended purpose, and is preferably 60% by mass or lower. When the content of the inorganic solid electrolyte is in the preferable range described above, there is an advantage that a better productivity is obtained.

### Second Embodiment

The inorganic solid electrolyte of the second embodiment is the same of the inorganic solid electrolyte of the first embodiment described above.

### <Dispersant>

### First Embodiment

The dispersant of the first embodiment is not particularly limited so long as the dispersant is soluble in the solvent, does not readily react with the inorganic solid electrolyte, and can disperse the inorganic solid electrolyte. Publicly-known dispersants or commercially available dispersants may be appropriately selected in accordance with the intended purpose. One dispersant may be used alone or two or more dispersants may be used in combination.

In the present specification, a dispersant soluble in the solvent represents one that is compatible with the solvent. More specifically, the dispersant can be considered dissolved in the solvent when no precipitate or supernatant is observed after the dispersant (3% by mass) is added and dissolved in the solvent, and then left in a stationary state for 10 minutes.

Specific examples of the dispersant include: polyethylene-based, polyethylene oxide-based, polypropylene oxide-based, polycarboxylic acid-based, naphthalene sulfonic acid formalin condensate-based, polyethylene glycol-based, polycarboxylic acid partial alkyl ester-based, polyether-based, polyethyleneimine-based, and polyalkylene polyamine-based high-molecular-weight dispersants; alkyl sulfonic acid-based, quaternary ammonium-based long-chain alcohol alkylene oxide-based, multivalent alcohol ester-based, and alkyl polyamine-based low-molecular-weight dispersants; and inorganic dispersants such as polyphosphoric acid salt dispersants.

The content of the dispersant in the liquid composition is not particularly limited and may be appropriately selected in accordance with the intended purpose. The solid concentration of the dispersant is preferably 10% by mass or lower and more preferably 3% by mass or lower relative to the solid electrolyte dispersed by the dispersant. When the content of the dispersant is outside the preferable range described above, there is a risk of flocculation due to the high dispersant concentration.

### Second Embodiment

The dispersant of the second embodiment is the same as the dispersant of the first embodiment described above.

### <Other Components>

The other components in the liquid composition according to the first embodiment and the second embodiment are not particularly limited and may be appropriately selected in accordance with the intended purpose so long as the effect of the present disclosure is not spoiled. Examples of the other components include publicly-known components used in solid electrolyte layers or electrode mixture layers. Specific examples of the other components include binders, active substances, and conductive assistants. One of these other components may be used alone or two or more of these other components may be used in combination.

The contents of the other components in the liquid composition are not particularly limited and may be appropriately selected in accordance with the intended purpose.

### —Binder—

The binder is not particularly limited and may be appropriately selected in accordance with the intended purpose so long as the binder can bind inorganic solid electrolytes with each other, or inorganic solid electrolytes with a base or an electrode active substance. Examples of the binder include high-molecular-weight compounds and high-molecular-weight particles. One binder may be used alone or two or more binders may be used in combination.

The high-molecular-weight compound is not particularly limited and may be appropriately selected in accordance with the intended purpose. Examples of the high-molecular-weight compound include polyamide compounds, polyimide compounds, polyamide imide, ethylene-propylene-butadiene rubbers (EPBR), styrene-butadiene rubbers (SBR), nitrile butadiene rubbers (NBR), isoprene rubbers, poly-isobutene, polyethylene glycol (PEO), polymethyl methacrylic acid (PMMA), and polyethylene vinyl acetate (PEVA).

High-molecular-weight particles may be used as a high-molecular-weight compound that can be dispersed in a liquid. The maximum particle diameter of the high-molecular-weight particles may be anything so long as it is smaller than the nozzle diameter of a liquid discharging head. The mode diameter of the high-molecular-weight particles is preferably from 0.01 micrometers through 1 micrometer. Examples of the material that constitute the high-molecular-weight particles include thermoplastic resins such as polyvinylidene fluoride, acrylic resins, styrene-butadiene rubbers, polyethylene, polypropylene, polyurethane, nylon, polytetrafluorocthylene, polyphenylene sulfide, polyethylene terephthalate, and polybutylene terephthalate.

### —Active Substance—

As the active substance, positive electrode active substances or negative electrode active substances that can be applied to electrochemical elements can be used.

The positive electrode active substance is not particularly limited so long as the positive electrode active substance can occlude and release alkali metal ions reversibly. Alkali metal-containing transition metal compounds can be used as the positive electrode active substance.

Examples of the alkali metal-containing transition metal compound include lithium-containing transition metal compounds such as composite oxides containing lithium and one or more elements selected from the group consisting of cobalt, manganese, nickel, chromium, iron, and vanadium.

Examples of the lithium-containing transition metal compounds include lithium cobaltate, lithium nickelate, lithium manganate, and nickel-cobalt lithium manganate.

As the alkali metal-containing transition metal compound, polyanion-based compounds that contain an XO₄ tetrahedron (for example, X=P,S, As, Mo, W, or Si) in the crystalline structure can also be used. Among these polyanion-based compounds, lithium-containing transition metal phosphoric acid compounds such as lithium iron phosphate and lithium vanadium phosphate are preferable in terms of cycle characteristics, and lithium vanadium phosphate is particularly preferable in terms of the co-efficient of lithium diffusion and the input/output characteristics of electrochemical elements.

In terms of electron conductivity, it is preferable that the polyanion-based compound be a composite material with its surface coated with a conductive assistant such as a carbon material.

The negative electrode active substance is not particularly limited so long as the negative electrode active substance can occlude and release alkali metal ions reversibly. Carbon materials containing graphite having a graphitic crystalline structure can be used as the negative electrode active substance.

Examples of the carbon materials include natural graphite, artificial graphite, sparingly graphitizable carbon (hard carbon), and easily graphitizable carbon (soft carbon).

Examples of the negative electrode active substance other than the carbon materials include lithium titanate, and titanium oxide.

In terms of the energy density of electrochemical elements, it is preferable to use high-capacity materials such as lithium metal, silicon, tin, silicon alloys, tin alloys, silicon oxide, silicon nitride, and tin oxide as the negative electrode active substance.

The content of the active substance in the liquid composition is not particularly limited, may be appropriately selected in accordance with the intended purpose, and is preferably 10% by mass or greater and more preferably 15% by mass or greater. When the content of the active substance in the liquid composition is 10% by mass or greater, it is possible to form an electrode mixture layer having a predetermined unit weight by a less number of times of printing.

### —Conductive Assistant—

The conductive assistant is not particularly limited and may be appropriately selected in accordance with the intended purpose. For example, carbon materials such as conductive carbon black, carbon nanofiber, carbon nanotube, graphene, and graphite particles can be used.

The conductive assistant may be a composite material combined with the active substance.

Conductive carbon black can be produced by, for example, a furnace method, an acetylene method, and a gasification method.

As conductive assistants other than the carbon materials, for example, metal particles and metal fibers of, for example, aluminum can be used.

The amount of the conductive assistant relative to the active substance is not particularly limited, may be appropriately selected in accordance with the intended purpose, and is preferably 10% by mass or less and more preferably 8% by mass or less.

### <Viscosity>

The viscosity of the liquid composition according to the first embodiment and the second embodiment is not particularly limited and may be appropriately selected in accordance with the intended purpose so long as the effect of the present disclosure is not spoiled, and is preferably a viscosity at which the liquid composition can be discharged through a nozzle of an inkjet head. More specifically, the viscosity of the liquid composition at 25° C. is preferably 200 mPa· s or lower, more preferably 100 mPa· s or lower, yet more preferably 50 mPa·s or lower, and particularly preferably 25 mPa·s or lower. The lower limit is not particularly limited and may be appropriately selected within a viscosity range in which the liquid composition can be discharged by an inkjet method.

The method for measuring the viscosity of the liquid composition is not particularly limited and may be appropriately selected in accordance with the intended purpose. For example, the viscosity can be measured with a B-type viscometer (cone plate viscometer) mounted with a rotor No. CPA-40Z. In the present specification, the viscosity of the liquid composition represents a viscosity at 25° C.

### <Maximum Particle Diameter>

The maximum particle diameter of solids contained in the liquid composition according to the first embodiment and the second embodiment is not particularly limited and may be appropriately selected in accordance with the intended purpose so long as the effect of the present disclosure is not spoiled. It is preferable that the maximum particle diameter of the solids be smaller than the nozzle diameter of an inkjet head. It is preferable that the maximum particle diameter of the solids be suf-ficiently smaller than the nozzle diameter of an inkjet head because a better inkjet dischargeability is obtained. Specifically, the ratio of the maximum particle diameter of the solids contained in the liquid composition to the nozzle diameter of an inkjet head (the maximum particle diameter of the solids contained in the liquid composition/the nozzle diameter of an inkjet head) is preferably 0.8 or less, more preferably 0.6 or less, and yet more preferably 0.5 or less. That is, when the nozzle diameter of an inkjet head is assumed to be 40 micrometers, the maximum particle diameter of the solids contained in the liquid composition is preferably 32 micrometers or less, more preferably 24 micrometers or less, and yet more preferably 20 micrometers or less.

The method for measuring the maximum particle diameter of the solids contained in the liquid composition is not particularly limited and may be appropriately selected in accordance with the intended purpose. For example, the maximum particle diameter of the solids can be measured according to, for example, ISO13320. The instrument used for the measurement is not particularly limited and may be appropriately selected in accordance with the intended purpose. Examples of the instrument include a laser diffraction/scattering particle diameter distribution analyzer (LA-960, available from Horiba, Ltd.).

The method for measuring the maximum particle diameter of a powder component used as a material of the liquid composition is not particularly limited and may be appropriately selected in accordance with the intended purpose. Examples of the method include a method using a laser diffraction method as in the method for measuring the maximum particle diameter of the solids contained in the liquid composition described above, and a method of obtaining the maximum particle diameter of a powder component from an image captured by scanning electron beam diffraction.

The method for producing the liquid composition is not particularly limited and may be appropriately selected in accordance with the intended purpose. For example, it is possible to prepare the liquid composition by adding the inorganic solid electrolyte and the dispersant, and other component as needed to the solvent, and mixing the resulting product.

The mixing unit is not particularly limited and may be appropriately selected in accordance with the intended purpose. Examples of the mixing unit include an ultrasonic homogenizer. The mixing conditions are not particularly limited and may be appropriately selected in accordance with the intended purpose.

The use of the liquid composition is not particularly limited and may be appropriately selected in accordance with the intended purpose. The liquid composition can be used as the material of a solid electrolyte layer of an all-solid-state secondary battery, or as a part involved in formation of a material of an electrode mixture layer.

### (Storage Container)

A storage container of the present disclosure is a storage container having stored therein the liquid composition of the present disclosure described above.

The shape, structure, and size of the storage container are not particularly limited and may be appropriately selected in accordance with the intended purpose.

### (Apparatus Configured to Produce Solid Electrolyte Layer or Electrode Mixture Layer, and Method for Producing Solid Electrolyte Layer or Electrode Mixture Layer)

An apparatus configured to produce a solid electrolyte layer or an electrode mixture layer of the present disclosure includes the storage container of the present disclosure described above, and a discharging unit configured to discharge the liquid composition stored in the storage container using an inkjet head, and further includes other components as needed.

A method for producing a solid electrolyte layer or an electrode mixture layer of the present disclosure includes a discharging step of discharging the liquid composition of the present disclosure described above using an inkjet head, and further includes other steps as needed.

### <Discharging Unit and Discharging Step>

The discharging unit is unit configured to discharge the liquid composition stored in the storage container using an inkjet head.

The discharging step is a step of discharging the liquid composition using an inkjet head.

By the discharging, it is possible to apply the liquid composition to a target and form a liquid composition layer.

The target (hereinafter, may be referred to as a “discharging destination”) is not particularly limited and may be appropriately selected in accordance with the intended purpose so long as it is a target on which a solid electrolyte layer or an electrode mixture layer is formed. Examples of the target include an active substance layer.

### <Other Components and Other Steps>

The other components of the apparatus configured to produce a solid electrolyte layer or an electrode mixture layer are not particularly limited and may be appropriately selected in accordance with the intended purpose so long as the effect of the present disclosure is not spoiled. Examples of the other components include a heating unit.

The other steps of the method for producing a solid electrolyte layer or an electrode mixture layer are not particularly limited and may be appropriately selected in accordance with the intended purpose so long as the effect of the present disclosure is not spoiled. Examples of the other steps include a heating step.

### —Heating Unit and Heating Step—

The heating unit is a unit configured to heat the liquid composition that has been discharged by the discharging unit.

The heating step is a step of heating the liquid composition discharged in the discharging step.

By this heating, it is possible to dry the liquid composition layer.

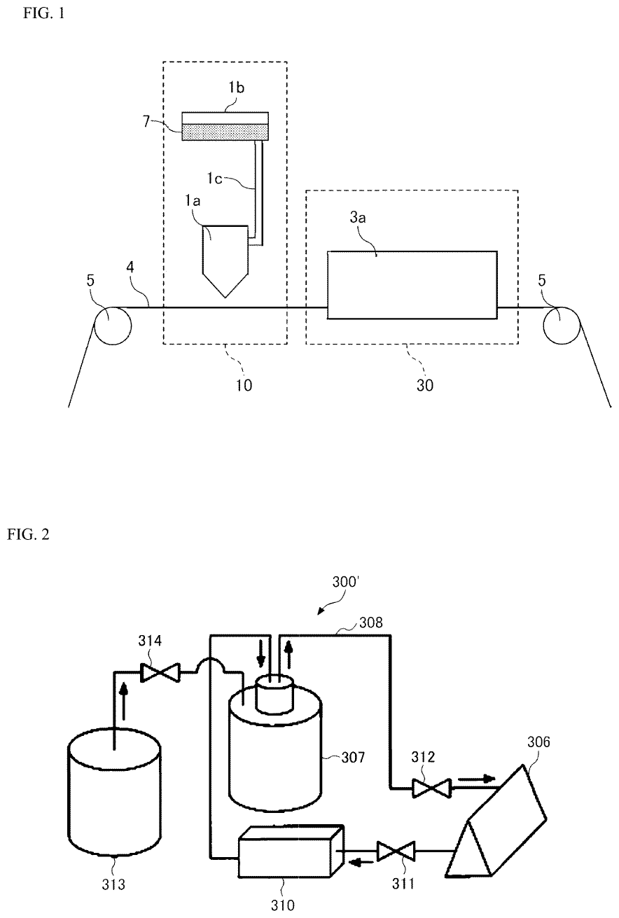

FIG. 1 illustrates an example view of the apparatus configured to produce a solid electrolyte layer or an electrode mixture layer for realizing the method for producing a solid electrolyte layer or an electrode mixture layer according to the present cm-bodiment.

The apparatus configured to produce a solid electrolyte layer or an electrode mixture layer illustrated in FIG. 1 is an apparatus configured to produce a solid electrolyte layer or an electrode mixture layer using the liquid composition described above. The solid electrolyte layer or electrode mixture layer apparatus includes a discharging step unit 10 including a step of applying the liquid composition to a print base material 4 having a discharging destination to form a liquid composition layer, and a heating step unit 30 including a heating step of heating the liquid composition layer to obtain a solid electrolyte layer or an electrode mixture layer. The solid electrolyte layer or electrode mixture layer apparatus includes a conveying unit 5 configured to convey the print base material 4. The conveying unit 5 conveys the print base material 4 to the discharging step unit 10 first and to the heating step unit 30 next at a previously set speed.

The method for producing the print base material 4 having the discharging destination such as the active substance layer mentioned above is not particularly limited, and a publicly-known method may be appropriately selected.

The discharging step unit 10 includes a printer 1a desirably selected to suit to an inkjet printing method, which is an applying method for realizing an applying step of applying the liquid composition to the print base material 4, a storage container 1b storing the liquid composition, and a supplying tube 1c through which the liquid composition stored in the storage container 1b is supplied to the printer 1a.

The storage container 1b stores the liquid composition 7. The discharging step unit 10 discharges the liquid composition 7 from the printer 1a and applies the liquid composition 7 to the print base material 4, to form a liquid composition layer in a thin film shape. The storage container 1b may be a form integrated with the solid electrolyte layer or electrode mixture layer apparatus, or may be a form detachable from the solid electrolyte layer or electrode mixture layer apparatus. Moreover, the storage container 1b may be a container used for adding the liquid composition into the storage container integrated with the solid electrolyte layer or electrode mixture layer apparatus, or into the storage container detachable from the solid electrolyte layer or electrode mixture layer apparatus.

The storage container 1b and the supplying tube 1c may be desirably selected so long as the liquid composition 7 can be stored and supplied stably.

As illustrated in FIG. 1, the heating step unit 30 includes a heater 3a, and includes a solvent removing step of removing the solvent remaining in the liquid composition layer by heating and drying by the heater 3a. As a result, a solid electrolyte layer or an electrode mixture layer can be formed. The heating step unit 30 may perform the solvent removing step at reduced pressure.

The heater 3a is not particularly limited and may be appropriately selected in accordance with the intended purpose. Examples of the heater 3a include substrate heating, an IR heater, and a hot air heater, or combinations of these.

The heating temperature or time may be appropriately selected in accordance with the boiling point of the solvent contained in the liquid composition 7 or the film thickness of the formed film.

FIG. 2 is an exemplary view illustrating another example of the apparatus (liquid discharging apparatus) configured to produce a solid electrolyte layer or an electrode mixture layer for realizing the method for producing a solid electrolyte layer or an electrode mixture layer according to the present embodiment.

A liquid discharging apparatus 300′ can circulate the liquid composition through a liquid discharging head 306, a tank 307, and a tube 308 by regulating a pump 310 and valves 311 and 312.

The liquid discharging apparatus 300′ includes an external tank 313, and can supply the liquid composition from the external tank 313 into the tank 307 by regulating the pump 310 and the valves 311, 312, and 314 when the liquid composition in the tank 307 has decreased.

Using the apparatus configured to produce a solid electrolyte layer or an electrode mixture layer, it is possible to discharge the liquid composition to the intended position on the discharging destination.

The solid electrolyte layer or the electrode mixture layer can be suitably used as a part of the configuration of, for example, a power storage element. Components other than the solid electrolyte layer or the electrode mixture layer of the power storage element are not particularly limited, and publicly-known components may be appropriately selected. Examples of the other components include a positive electrode, a negative electrode, and a separator.

As the method for producing the power storage element, a publicly-known method may be appropriately selected so long as a solid electrolyte layer or an electrode mixture layer of the method are changed to those of the present disclosure.

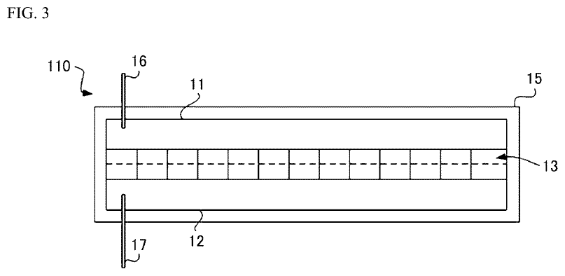

The shape of the power storage element is not particularly limited and may be appropriately selected in accordance with the intended purpose. The shape of the power storage element may be not only the shape illustrated in FIG. 3, but may be appropriately selected from various commonly employed shapes in accordance with use of the power storage element. The shape is not particularly limited and may be appropriately selected in accordance with the intended purpose. Examples of the shape include a cylinder type in which a sheet electrode and a solid electrolyte layer are spirally shaped, a cylinder type having an inside-out structure in which a pellet electrode and a solid electrolyte layer are combined, and a coin type in which a pellet electrode and a solid electrolyte layer are laminated.

FIG. 3 is an exemplary view illustrating an example of a power storage element including the solid electrolyte layer according to the present embodiment.

As illustrated in FIG. 3, the power storage element 110 according to the present embodiment includes a positive electrode 11, a negative electrode 12 counter to the positive electrode 11, and a solid electrolyte layer 13 disposed between the positive electrode 11 and the negative electrode 12.

The power storage element 110 includes a container 15 serving as an exterior can that holds the positive electrode 11, the negative electrode 12, and the electrolyte layer 13 by enclosing them, a positive electrode line 16 penetrating the container 15 to couple to the positive electrode 11, and a negative electrode line 17 likewise penetrating the container 15 to couple to the negative electrode 12.

### <Use>

The use of the power storage element is not particularly limited, and the power storage element has various uses. Examples of the uses of the power storage element include; power supplies for, for example, laptop personal computers, stylus personal computers, mobile personal computers, electronic book players, portable phones, portable facsimile machines, portable copiers, portable printers, stereo headsets, hand-held video recorders/players, liquid crystal television sets, hand-held cleaners, portable CD players, mini disk players, transceivers, electronic organizers, calculators, memory cards, portable tape recorders, radios, motors, lighting equipment, toys, game consoles, clocks, stroboscopes, and cameras; and backup power supplies.

### EXAMPLES

The present disclosure will be described in detail below by way of Examples. The present disclosure should not be construed as being limited to these Examples.

In order to suppress reaction between an inorganic solid electrolyte and moisture in the air, operations described below were performed in an argon glovebox maintained at a dew point of −70° C. or lower, unless otherwise particularly specified.

### Preparation Example 1: Synthesis of Inorganic Solid Electrolyte 1

As an inorganic solid electrolyte 1, an argyrodite-type sulfide solid electrolyte Li₆PS₅Cl (LPSC) was synthesized according to Document 1 (Deiseroth H.-J., S.-T. Kong, H. Eckert, J. Vannahme, C. Reiner, T. Zaiss and M. Schlosser, Angew. Chem., International Edition 47, 2008, pp. 755-758).

### Preparation Example 2: Synthesis of Inorganic Solid Electrolyte 2

As an inorganic solid electrolyte 2, an inorganic oxide solid electrolyte Li₇La₃Zr₂O₁₂ (LLZ) was synthesized according to Document 2 (Murugan R., V. Thangadurai, and W. Weppner, Angew. Chem., International Edition 46, 2007, pp. 7778-7781).

### Examples 1 to 5 and Comparative Examples 1 to 4: Production of Liquid Composition

In Examples 1 to 5 and Comparative Examples 1 to 4 below, an inorganic solid electrolyte and a dispersant were added to a dehydrated solvent, and the resulting product was mixed using an ultrasonic homogenizer, to obtain a liquid composition. As the dehydrated solvent, one that was confirmed to have a water content of 100 ppm or less by a Karl Fischer moisture titrator was used.

For the liquid compositions of Examples 1 to 5 and Comparative Examples 1 to 4 below, detection of hydrogen sulfide, measurement of the maximum particle diameter of the solids contained in the liquid composition, measurement of the viscosity of the liquid composition, and evaluation of inkjet dischargeability were performed in the manners described below.

### <Detection of Hydrogen Sulfide>

Whether hydrogen sulfide was emitted from the mixed liquid composition was judged in the manner described below.

The liquid composition (10 mL) was poured into a screw tube and stored in an argon glovebox at 25° C. for 1 hour. After the storage, a hydrogen sulfide sensor (obtained from Honeywell Japan Ltd., BW SOLO LITE) was brought close to the screw tube and the screw tube was opened. Here, when the hydrogen sulfide sensor kept displaying a value greater than or equal to 0.1 ppm for 3 seconds or longer, it was judged that hydrogen sulfide was emitted.

### —Evaluation—

a: Hydrogen sulfide emission was absent.
b: Hydrogen sulfide emission was present.

### <Measurement of Maximum Particle Diameter of Solids Contained in Liquid Composition>

The maximum particle diameter of the solids contained in the liquid composition was obtained in the manner described below according to ISO13320.

First, using the same solvent as that contained in the liquid composition, the liquid composition was diluted to a solid concentration of from 0.1 ppm through 10 ppm, to obtain a diluted liquid. The diluted liquid was poured into a quartz glass container, which was then sealed with a gasket. Next, the quartz glass container sealed with the gasket was taken out from the glovebox, and the maximum particle diameter was calculated using a laser diffraction/scattering particle diameter distribution analyzer (LA-960, obtained from Horiba, Ltd.). Here, the dilution concentration was adjusted in a manner that the transmissive light intensity of the laser diffraction/scattering particle diameter distribution analyzer was in an appropriate range, using the same solvent as that contained in the liquid composition.

### <Viscosity of Liquid Composition>

The viscosity of the liquid composition at 100 rpm at 25° C. was measured with a B-type viscometer (cone plate viscometer) mounted with a rotor No. CPA-40Z.

### <Inkjet Dischargeability>

Using a liquid droplet observation instrument EV1000 (obtained from Ricoh Company, Ltd.), the inkjet dischargeability of the liquid composition was evaluated in the manner described below.

The liquid composition to be evaluated was discharged from one nozzle (having a nozzle diameter of 40 micrometers) of the inkjet head of EV1000. If the liquid composition could be continuously discharged for 60 seconds or longer, it was determined that the liquid composition had dischargeability. With a liquid composition that could be continuously discharged for 60 seconds or longer, the amount of the liquid composition discharged is no object so long as the liquid composition was kept discharged at least 60 seconds after it started to be discharged. That is, so long as the liquid composition could be continuously discharged for at least 60 seconds from when it started to be discharged, it does not matter whether the amount of the liquid composition discharged had changed or had not changed through the period of time from the start of discharging until 60 seconds after the start of discharging.

### —Evaluation—

A: The liquid composition had dischargeability (could be continuously discharged for 60 seconds or longer).
B: The liquid composition had no dischargeability (could not be continuously discharged for 60 seconds).

### Example 1: Liquid Composition a

The inorganic solid electrolyte 1 (having a solid concentration of 20% by mass) and a dispersant A (obtained from Lubrizol Corporation, S13940, having a solid concentration of 1% by mass) having compatibility with octane were added to octane (having a relative permittivity of 2.1, obtained from Tokyo Chemical Industry Co., Ltd.), and the resulting product was mixed using an ultrasonic homogenizer, to produce a liquid composition A.

Hydrogen sulfide emission was not detected from the obtained liquid composition A.

The maximum particle diameter of the solids contained in the obtained liquid composition A was 2 micrometers.

The viscosity of the obtained liquid composition A was 9 mPa·s.

The inkjet dischargeability of the obtained liquid composition A was examined using EV1000. It was confirmed that the liquid composition A could be continuously discharged for 60 seconds.

### Example 2: Liquid Composition B

The inorganic solid electrolyte 1 (having a solid concentration of 30% by mass) and a dispersant B (obtained from Lubrizol Corporation, S21000, having a solid concentration of 1% by mass) having compatibility with 1,2-diethoxyethane were added to 1,2-diethoxyethane (having a relative permittivity of 5.0, obtained from FUJIFILM Wako Pure Chemical Corporation), and the resulting product was mixed using an ultrasonic homogenizer, to produce a liquid composition B.

Hydrogen sulfide emission was not detected from the obtained liquid composition B.

The maximum particle diameter of the solids contained in the obtained liquid composition B was 2 micrometers.

The viscosity of the obtained liquid composition B was 10 mPa·s.

The inkjet dischargeability of the obtained liquid composition B was examined using EV1000. It was confirmed that the liquid composition B could be continuously discharged for 60 seconds.

### Example 3: Liquid Composition C

The inorganic solid electrolyte 1 (having a solid concentration of 50% by mass) and the dispersant B (having a solid concentration of 1% by mass) having compatibility with 1,2-diethoxyethane were added to 1,2-diethoxyethane (having a relative permittivity of 5.0, obtained from FUJIFILM Wako Pure Chemical Corporation), and the resulting product was mixed using an ultrasonic homogenizer, to produce a liquid composition C.

Hydrogen sulfide emission was not detected from the obtained liquid composition C. The maximum particle diameter of the solids contained in the obtained liquid composition C was 2 micrometers.

The viscosity of the obtained liquid composition C was 12 mPa·s.

The inkjet dischargeability of the obtained liquid composition C was examined using EV1000. It was confirmed that the liquid composition C could be continuously discharged for 60 seconds.

### Example 4: Liquid Composition D

The inorganic solid electrolyte 2 (having a solid concentration of 30% by mass) and a dispersant C (obtained from NOF Corporation, SC-1015F, having a solid concentration of 1% by mass) having compatibility with 1,2-diethoxyethane were added to 1,2-diethoxyethane (having a relative permittivity of 5.0, obtained from FUJIFILM Wako Pure Chemical Corporation), and the resulting product was mixed using an ultrasonic homogenizer, to produce a liquid composition D.

Because the inorganic solid electrolyte 2 did not contain sulfur in the composition, presence or absence of hydrogen sulfide emission from the liquid composition D was not examined.

The maximum particle diameter of the solids contained in the obtained liquid composition D was 2 micrometers.

The viscosity of the obtained liquid composition D was 11 mPa·s.

The inkjet dischargeability of the obtained liquid composition D was examined using EV1000. It was confirmed that the liquid composition D could be continuously discharged for 60 seconds.

### Example 5: Liquid Composition E

The inorganic solid electrolyte 1 (having a solid concentration of 30% by mass) and a dispersant D (obtained from Lubrizol Corporation, S17000, having a solid concentration of 1% by mass) having compatibility with ethyl propionate were added to ethyl propionate (having a relative permittivity of 5.7, obtained from FUJIFILM Wako Pure Chemical Corporation), and the resulting product was mixed using an ultrasonic homogenizer, to produce a liquid composition E.

Hydrogen sulfide emission was not detected from the obtained liquid composition E.

The maximum particle diameter of the solids contained in the obtained liquid composition E was 2 micrometers.

The viscosity of the obtained liquid composition E was 10 mPa·s.

The inkjet dischargeability of the obtained liquid composition E was examined using EV1000. It was confirmed that the liquid composition E could be continuously discharged for 60 seconds.

### Comparative Example 1: Liquid Composition F

The inorganic solid electrolyte 1 (having a solid concentration of 30% by mass) and the dispersant D (having a solid concentration of 1% by mass) having compatibility with methyl propionate were added to methyl propionate (having a relative permittivity of 6.2, obtained from FUJIFILM Wako Pure Chemical Corporation), and the resulting product was mixed using an ultrasonic homogenizer, to produce a liquid composition F.

Hydrogen sulfide emission was detected from the obtained liquid composition F.

Because hydrogen sulfide emission was detected from the liquid composition F, it was impossible to examine the maximum particle diameter of the solid concentration contained in the liquid composition F, the viscosity of the liquid composition F, and the inkjet dischargeability of the liquid composition F by EV1000.

### Comparative Example 2: Liquid Composition G

The inorganic solid electrolyte 1 (having a solid concentration of 10% by mass) was added to octane (having a relative permittivity of 2.1, obtained from Tokyo Chemical Industry Co., Ltd.), and the resulting product was mixed using an ultrasonic homogenizer, to produce a liquid composition G.

Hydrogen sulfide emission was not detected from the obtained liquid composition G.

The maximum particle diameter of the solids contained in the obtained liquid composition G was 100 micrometers.

The viscosity of the obtained liquid composition G was 5 mPa·s.

The inkjet dischargeability of the obtained liquid composition G was examined using EV1000. It was confirmed that the liquid composition G could not be continuously discharged for 60 seconds.

### Comparative Example 3: Liquid Composition H

The inorganic solid electrolyte 1 (having a solid concentration of 30% by mass) and a dispersant E (obtained from Sigma-Aldrich Co. LLC, TRITON-X100, having a solid concentration of 1% by mass) having no compatibility with octane were added to octane (having a relative permittivity of 2.1, obtained from Tokyo Chemical Industry Co., Ltd.), and the resulting product was mixed using an ultrasonic homogenizer, to produce a liquid composition H. Because the dispersant E was insoluble in octane serving as the solvent, the liquid composition H was observed to be in a phase-separated state.

Hydrogen sulfide emission was not detected from the obtained liquid composition H.

The maximum particle diameter of the solids contained in the obtained liquid composition H was 90 micrometers.

The viscosity of the obtained liquid composition H was 25 mPa·s.

The inkjet dischargeability of the obtained liquid composition H was examined using EV1000. It was confirmed that the liquid composition H could not be continuously discharged for 60 seconds.

### Comparative Example 4: Liquid Composition I

The inorganic solid electrolyte 2 (having a solid concentration of 10% by mass) was added to 1,2-diethoxyethane (having a relative permittivity of 5.0, obtained from FUJIFILM Wako Pure Chemical Corporation), and the resulting product was mixed using an ultrasonic homogenizer, to produce a liquid composition I.

Because the inorganic solid electrolyte 2 did not contain sulfur in the composition, presence or absence of hydrogen sulfide emission from the liquid composition I was not examined.

The maximum particle diameter of the solids contained in the obtained liquid composition I was 80 micrometers.

The viscosity of the obtained liquid composition I was 10 mPa·s.

The inkjet dischargeability of the obtained liquid composition I was examined using EV1000. It was confirmed that the liquid composition I could not be continuously discharged for 60 seconds.

The results of Examples and Comparative Examples described above are presented in Table 1 below. In the item “presence or absence of hydrogen sulfide emission” in Table 1, “a” represents that “hydrogen sulfide emission was absent” and “b” represents that “hydrogen sulfide emission was present”.

TABLE 1

| | | | | | | | | | Liquid composition | | | |
|---|---|---|---|---|---|---|---|---|---|---|---|---|
| | | | | | Inorganic solid | | | | Presence | | | |
| | | | | | electrolyte | | Dispersant | | or | Maximum | | |
| | | | | | | Solid | | Presence or | absence | particle | | |
| | | | Solvent | | | concentration | | absence of | of | diameter | | |
| | | | | Relative | | (% by mass) | | compatibility | hydrogen | (μm) | | Inkjet |
| | | Liquid | | permittivity | | in liquid | | with | sulfide | of solid | Viscosity | discharge- |
| | | composition | Kind | (25° C.) | Kind | composition | Kind | solvent | emission | content | (mPa · s) | ability |
| Ex. | 1 | A | Octane | 2.1 | 1 | 20 | A | present | a | 2 | 9 | A |
| | 2 | B | 1,2- | 5.0 | 1 | 30 | B | present | a | 2 | 10 | A |
| | | | Diethoxyethane | | | | | | | | | |
| | 3 | C | 1,2- | 5.0 | 1 | 50 | B | present | a | 2 | 12 | A |
| | | | Diethoxyethane | | | | | | | | | |
| | 4 | D | 1,2- | 5.0 | 2 | 30 | C | present | a | 2 | 11 | A |
| | | | Diethoxyethane | | | | | | | | | |
| | 5 | E | Ethyl | 5.7 | 1 | 30 | D | present | a | 2 | 10 | A |
| | | | propionate | | | | | | | | | |
| Comp. | 1 | F | Methyl | 6.2 | 1 | 30 | D | present | b | — | — | — |
| Ex. | | | propionate | | | | | | | | | |
| | 2 | G | Octane | 2.1 | 1 | 10 | none | — | a | 100 | 5 | B |
| | 3 | H | Octane | 2.1 | 1 | 30 | E | absent | a | 90 | 25 | B |
| | 4 | I | 1,2- | 5.0 | 2 | 10 | none | — | a | 80 | 10 | B |
| | | | Diethoxyethane | | | | | | | | | |

Aspects of the Present Disclosure are, for Example, as Follows.

<1> A liquid composition, including:
a solvent;
an inorganic solid electrolyte; and
a dispersant, wherein
a solid concentration of the inorganic solid electrolyte in the liquid composition is 20% by mass or higher,
the dispersant is soluble in the solvent, and
a relative permittivity of the solvent at 25° C. is 6.0 or lower.

<2> The liquid composition according to <1>,
wherein a viscosity of the liquid composition is 200 mPa· s or lower.

<3> The liquid composition according to <1> or <2>,
wherein a maximum particle diameter of solids contained in the liquid composition is 32 micrometers or less.

<4> A liquid composition, including:
a solvent;
an inorganic solid electrolyte; and
a dispersant, wherein
a solid concentration of the inorganic solid electrolyte in the liquid composition is 20% by mass or higher,
the dispersant is soluble in the solvent,
a relative permittivity of the solvent at 25° C. is 6.0 or lower, and
the liquid composition is for being discharged using an inkjet head.

<5> The liquid composition according to <4>,
wherein a viscosity of the liquid composition is a viscosity at which the liquid composition can be discharged through a nozzle of the inkjet head.

<6> The liquid composition according to <4> or <5>,
wherein a maximum particle diameter of solids contained in the liquid composition is smaller than a nozzle diameter of the inkjet head.

<7> The liquid composition according to any one of <4> to <6>,
wherein a ratio of a maximum particle diameter of solids contained in the liquid composition to a nozzle diameter of the inkjet head is 0.8 or less.

<8> The liquid composition according to any one of <1> to <7>,
wherein the inorganic solid electrolyte contains elemental sulfur in a composition formula thereof.

<9> A storage container, including
the liquid composition according to any one of <1> to <8>,
wherein the liquid composition is stored in the storage container.

<10> An apparatus configured to produce a solid electrolyte layer or an electrode mixture layer, the apparatus including:
the storage container according to <9>; and
a discharging unit configured to discharge the liquid composition stored in the storage container using an inkjet head.

<11> A method for producing a solid electrolyte layer or an electrode mixture layer, the method including:
discharging the liquid composition according to any one of <1> to <8> using an inkjet head.

The liquid composition according to any one of <1> to <8>, the storage container according to <9>, the apparatus configured to produce a solid electrolyte layer or an electrode mixture layer according to <10>, and the method for producing a solid electrolyte layer or an electrode mixture layer according to <11> can solve the various problems in the related art and achieve the object of the present disclosure.

### REFERENCE SIGNS LIST

1a printer
1b storage container
1c supplying tube
3a heater
4 print base material
5 conveying unit
7 liquid composition
10 discharging step unit
11 positive electrode
12 negative electrode
13 solid electrolyte layer
15 container
16 positive electrode line
17 negative electrode line
30 heating step unit
110 power storage element
300′ liquid discharging apparatus
306 liquid discharging head
307 tank
308 tube
310 pump
311 valve
312 valve
313 external tank
314 valve

The present application is based on and claims priority to Japanese patent application No. 2021-204139, filed on Dec. 16, 2021, the entire contents which are hereby incorporated herein by reference.

1. A liquid composition, comprising:
a solvent;
an inorganic solid electrolyte; and
a dispersant, wherein a solid concentration of the inorganic solid electrolyte in the liquid composition is 20% by mass or higher, the dispersant is soluble in the solvent, and a relative permittivity of the solvent at 25° C. is 6.0 or lower.

2. The liquid composition according to claim 1, wherein a viscosity of the liquid composition is 200 mPa· s or lower.

3. The liquid composition according to claim 1, wherein a maximum particle diameter of solids contained in the liquid composition is 32 micrometers or less.

4. A liquid composition, comprising:
a solvent;
an inorganic solid electrolyte; and
a dispersant, wherein a solid concentration of the inorganic solid electrolyte in the liquid composition is 20% by mass or higher, the dispersant is soluble in the solvent, a relative permittivity of the solvent at 25° C. is 6.0 or lower, and the liquid composition is for being discharged using an inkjet head.

5. The liquid composition according to claim 4, wherein a viscosity of the liquid composition is a viscosity at which the liquid composition can be discharged through a nozzle of the inkjet head.

6. The liquid composition according to claim 4, wherein a maximum particle diameter of solids contained in the liquid composition is smaller than a nozzle diameter of the inkjet head.

7. The liquid composition according to claim 4, wherein a ratio of a maximum particle diameter of solids contained in the liquid composition to a nozzle diameter of the inkjet head is 0.8 or less.

8. The liquid composition according to claim 1, wherein the inorganic solid electrolyte contains elemental sulfur in a composition formula thereof.

9. A storage container, comprising the liquid composition according to claim 1, wherein the liquid composition is stored in the storage container.

10. An apparatus configured to produce a solid electrolyte layer or an electrode mixture layer, the apparatus comprising:
the storage container according to claim 9; and
a discharger to discharge the liquid composition stored in the storage container using an inkjet head.

11. A method for producing a solid electrolyte layer or an electrode mixture layer, the method comprising:
discharging the liquid composition according to claim 1, using an inkjet head.
